(19) United States
(12) Patent Application Publication
(10) Pub. No.: US 2025/0101732 A1
(43) Pub. Date: Mar. 27, 2025

(54) CONCEALED STRUCTUAL ELEMENT FASTENING SYSTEM

(71) Applicant: Nicolaas Hendrik Hickley, Centurion (ZA)

(72) Inventor: Nicolaas Hendrik Hickley, Centurion (ZA)

(21) Appl. No.: 18/291,281

(22) PCT Filed: Jul. 28, 2022
(86) PCT No.: PCT/IB2022/056978

§ 371 Date: Jan. 23, 2024

(30) Foreign Application Priority Data
Jul. 28, 2021 (ZA) 2021/05327

(51) Int. Cl. E04B 1/343; E04B 1/38; F16B 5/00

(52) U.S. Cl. CPC E04B 1/34315; F16B 5/0056; E04B 2001/389

(57) ABSTRACT

The invention comprises a concealed structural element fastening system (1) comprising a first structural element (2) and a second structural element (3), and a fastener (4) configured to secure the first structural element (2) and the second structural element (3) to, and in abutment with, each other; with the first structural element (2) including a fastener guide configured to movably secure the fastener (4) to the first structural element (2) and guide movement of the fastener (4) along an engagement path between a disengaged position and an engaged position; with the fastener (4) including an engagement formation complementarity configured to an engagement formation on the second structural element (3), operatively for the engagement formations of the fastener (4) and the second structural element (3) to become engaged with movement of the fastener (4) from the disengaged position to the engaged position to secure the second structural element (3) to the first structural element (2).

### FIELD OF THE INVENTION

This invention relates to a fastening system for a structural element.

### BACKGROUND TO THE INVENTION

Many structures are assembled from structural elements that comprise composite materials, such as plastics. The assembly of such structures require that various elements be positioned in specific relative orientations to each other, and that they be secured in such orientations.

One example of such a structure is a portable toilet. It is comprised of structural elements including moulded plastic panels which form the base, pillars, side panels and top of the toilet. Four rectangularly shaped side panels are secured to four corner pillars by means of rivets to form an upright cubicle. Each side panel is secured to a pillar on each side thereof by means of multiple rivets, with the entire structure requiring dozens of rivets. One side panel includes a door for the toilet.

The assembled structure is not entirely stable, and typically there is some movement in it, coming from joints created using rivets. This allows some lateral movement of the panels, which is not ideal.

The assembly of such a structure requires at least a rivet gun and a supply of rivets, which is not always available on site where such assembled structures are intended to be used. This prevents, at least in some instances, such structures to be transported in flat-packed disassembled form. Instead, they are transported fully assembled, which dramatically increases transport cost and exposes such assembled structures to transport-inflicted damage.

Once the structure is assembled in this manner it cannot be easily disassembled, at least not without removing the rivets which typically requires drilling them out. That is a laborious task that may also damage the apertures through which the rivets have to be located, which compromises the future structural integrity of such a toilet when it is assembled again. This effectively renders impractical the disassembly of such a structure once it has been assembled.

This limitation is not applicable only to portable toilets. By way of further example, some tool sheds are also manufactured from moulded composite materials to form structural elements for assembly. These also typically have side panels and corner pillars that form walls of the structure.

The same also applies to structures such as portable huts, and low-cost structures that are typically not transported very often between locations where they are used, for example guard huts, and small cabins colloquially known as Wendy-houses. Although some of these structures were historically manufactured from wood, there are modern variants of them that are made from plastic panels, and they also suffer from the problems described above.

Even though structures of the type described above are intended to be used as relatively low-cost functional units, they must still be aesthetically pleasing, especially where both sides of their panels are visible. Therefore, such structural elements are generally expected, in terms of moulding, to have “A” surface finishes on both sides thereof. This also means, from an aesthetic perspective, that ideally such structural elements should not have unsightly visible braces, or the like, that serve as fasteners between adjoining structural elements.

There is a need for a structural element fastening system that at least partly overcomes these problems and provides a neat and structurally sound assembled product.

### OBJECTIVE OF THE INVENTION

It is an objective of the invention to provide a structural element fastening system which at least partly overcomes the abovementioned problems.

### SUMMARY OF THE INVENTION

In accordance with this invention there is provided a concealed structural element fastening system comprising a first structural element and a second structural element, and a fastener configured to secure a first structural element and a second structural element to, and in abutment with, each other;
with the first structural element including a fastener guide configured to movably secure the fastener to the first structural element and guide movement of the fastener along an engagement path between a disengaged position and an engaged position;
with the fastener including an engagement formation complimentary configured to an engagement formation on the second structural element,
operatively for the engagement formations of the fastener and the second structural element to become engaged with movement of the fastener from the disengaged position to the engaged position to secure the second structural element to the first structural element.

There is further provided for the second structural element to have a sliding fit with the first structural element, and preferably into a complementary shaped and sized space in the first structural element, and more preferably for the space to comprise a groove.

There is still further provided for the first structural element to comprise a pillar and for the second structural element to comprise a panel, with the pillar including a longitudinal groove provided along an edge thereof, and for the panel to include a longitudinal edge complimentary shaped and sized to fit into the groove at least partially, with the fastener located within the pillar and the panel's engaging formation being integrated within its edge.

There is still further provided for the pillar to comprise a structure comprised of an operatively outer wall and an operatively inner wall, spaced apart by an internal wall extending between them,
with the internal wall including for each fastener an aperture in the internal wall,
a passage extending from an edge of each aperture to and through the pillar wall closest to it;
with the passage shaped and sized to allow a screw threaded bolt to extend through the wall through which the passage extends into the aperture in the internal wall of the pillar,
with the fastener including a base with an aperture complementary shaped to the shaft of bolt and being screw threaded complementary to bolt,
and with the fastener guide comprising a set of spaced apart protrusions on an operatively top edge and operatively bottom edge of the fastener, with each set of protrusions defining between them a guide gap for the fastener to have a top guide gap and a bottom guide gap,
with the top and bottom guide gaps being complimentary shaped and sized to a thickness of the internal wall of the pillar at the operatively upper and lower edges of the aperture in the internal wall, to allow sliding movement of the movement along the operatively upper and lower edges of the aperture in the internal wall operatively providing the engagement path for the fastener;
with the fastener installed in the aperture in the internal wall in screw threaded engagement with the bolt, and with the top and bottom guide gaps of the fastener being located in sliding engagement operatively upper and lower edges of the aperture in the internal wall;
for rotation of the bolt to move the fastener between a disengaged position distal from the bolt passage and an engaged position proximate the bolt passage;
with the fastener further including a set of side tabs each terminating in an engagement formation that is complementary shaped and sized to an associated engagement formation on a second structural element,
operatively for movement of the fastener from its disengaged towards its engaged position to align and engage the engagement formation of each tab of the fastener with an associated complimentary engagement formation within its associated second structural element, and with movement of the fastener to its engaged position to secure the second structural element to the first structural element by drawing it into the first structural element under force of the engagement of the associated engagement formations of the fastener and the second structural element.

There is further provided for the engagement formation of each of the fastener side tabs to comprise an aperture through the tab, and for the engagement formation of the second structural element to comprise a hook; alternatively, for the engagement formation of each of the fastener side tabs to comprise a hook extending from the tab, and for the engagement formation of the second structural element to comprise an aperture in a tab extending from the second structural element.

There is further provided for the passage to extend through the outer wall of the pillar.

There is also provide for the first and second structural elements to include a sliding fit guide comprising a set of spaced apart ribs on one of the first and second structural elements, and a set of complementary notches on the other, with the ribs and notches guiding sliding of the edge of the second structural element into the groove of the first structural element.

There is further provided for the first structural element comprise a pillar and for the second structural element to comprise a panel, and more preferably for the pillar to comprise a corner pillar of a structure and for the panel to comprise a wall of the structure, and further preferably for each pillar to provide fitment of a panel on either longitudinal side thereof.

These and other features of the invention are described in more detail below.

### BRIEF DESCRIPTION OF THE DRAWINGS

Two embodiments of the invention are described by way of example only and with reference to the accompanying drawings in which:

FIG. 1 is a front orthographic view of part of assembly according to a first embodiment of the invention, including a corner pillar of a portable toilet, shown with part of a wall panel engaged with it on either side thereof;

FIG. 2 is a front orthographic view of a fastener forming part of the assembly of FIG. 1;

FIG. 3 is a top right orthographic view of the pillar shown in FIG. 1 without the wall panels and the fastener of FIG. 2;

FIG. 4 shows the pillar of FIG. 3 with the fastener of FIG. 2, and excluding the wall panels;

FIG. 5 is a bottom orthographic view of the pillar shown in FIG. 4;

FIG. 6 is a bottom orthographic view of the left wall panel of the assembly of FIG. 1;

FIG. 7 is a bottom orthographic view of the left panel of the assembly of FIG. 1, with the fastener of FIG. 2;

FIG. 8 is a bottom orthographic view of the assembly of FIG. 1;

FIG. 9 is a front orthographic view of part of an assembly according to a second embodiment of the invention including a side pillar of a portable toilet, shown with part of a wall panel engaged with it on either side thereof;

FIG. 10 is a front orthographic view of a fastener forming part of the assembly of FIG. 9;

FIG. 11 is a left side orthographic view of the side pillar of the assembly of FIG. 9, with the fastener of FIG. 10;

FIG. 12 is a front orthographic view of the left side panel of the assembly of FIG. 9, with the fastener of FIG. 10; and

FIG. 13 is a bottom orthographic view of the assembly of FIG. 9.

### DETAILED DESCRIPTION OF THE INVENTION

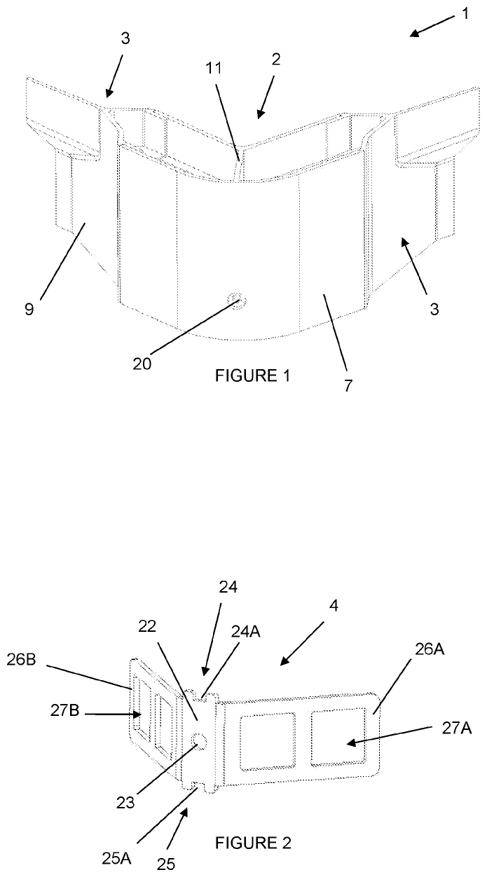

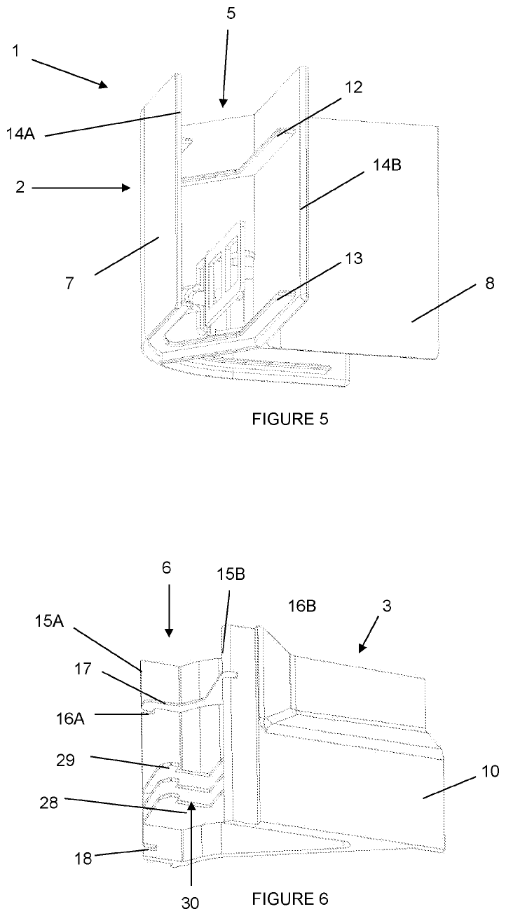

A first embodiment of a concealed structural element fastening system according to the invention is shown in FIGS. 1 to 8.

The fastening system (1) includes a first structural element (2), a second structural element (3) and a fastener (4). In this first embodiment, the first structural element comprises a corner pillar (2) of a portable toilet, and the second structural element comprises a sidewall (3) of the portable toilet. In FIG. 1 two sidewalls (3) are shown.

The portable toilet includes four of the corner pillars (2), three sidewalls (3), and a door (not shown). The panel that includes the door, is secured to its adjoining pillars (2) in the same manner as the three other sidewalls (3).

For the sake of simplicity, the drawings show only a portion of one corner pillar (2) with or without its two adjoining sidewalls (3). It will be appreciated that the corner pillar (2) has a length determined by the desired height of the portable toilet, and the two sidewalls (3) have complementary lengths, and each sidewall has a width determined by its function.

To assemble the portable toilet, a longitudinal edge (6) of a sidewall (3), shown in FIG. 6, is slid into a complementary sized longitudinal groove (5) in each side of the pillar (2), with one sidewall (3) on each side of the pillar (2). The opposing longitudinal edge (not shown) of each sidewall (3) is slid into a similar pillar (2), with four pillars (2) and four sidewalls (3), one of which includes the door, completing the vertical assembly of the portable toilet. The portable toilet structural assembly is completed by securing this vertical assembly on a floor panel and securing a roof panel to its top.

It will be appreciated that the integrity of the portable toilet depends to a large degree on the engagement between the pillars (2) and sidewalls (3), even though the floor panel and roof panel off the toilet also assist in structural stability. Each pillar (2) is provided with a fastening system (1) according to the invention in a plurality of locations along the length of the pillar, with corresponding features along the edges of the sidewalls (3). Typically, four or five fastening systems are spaced along the length of each pillar (2).

Each pillar (2) includes an external surface (7) and an internal surface (8). Similarly, each sidewall (3) includes a complementary external surface (9) and a complementary internal surface (10).

The external (7) and internal (8) surfaces of the pillar (2) is divided by a central internal wall (11), the width of which determines the thickness of the pillar (2).

The operative outside of the external surfaces (7, 9) and the internal surfaces (8, 10) are provided with “A” grade (high quality) surface finishes, since these are visible.

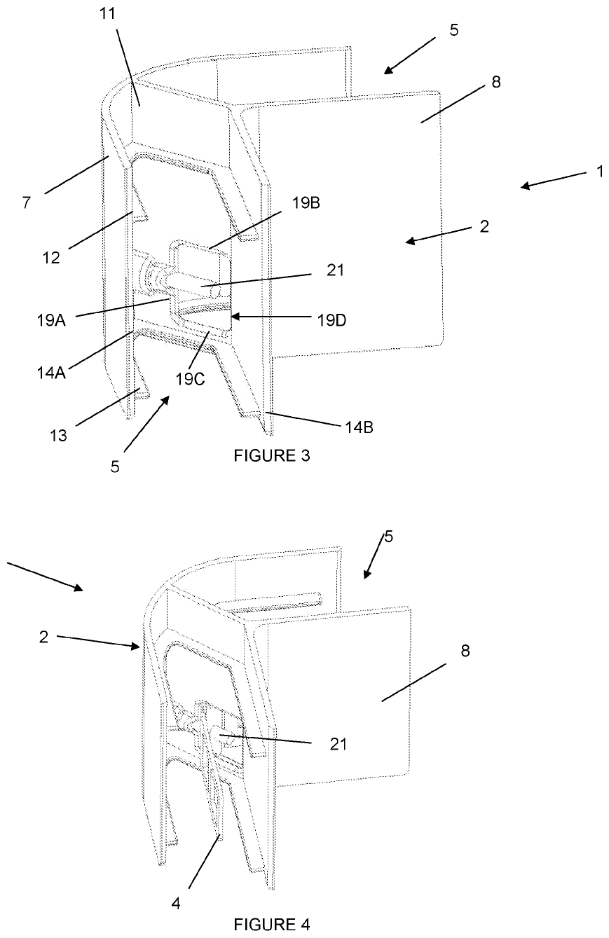

Each pillar (2) is provided, on each side of a central internal wall (11), with a set of spaced apart ribs (12, 13), with one (12) above and another (13) below the fastener element position (4) of the system (1). As shown most clearly in FIGS. 3 to 6, the ribs (12, 13) each terminate at a predetermined distance inward from the longitudinal edges (14A, 14B) of the pillar (2).

The longitudinal edge (15) of each sidewall (3) comprises two spaced apart edges (15A, 15B), which are complementary shaped to the groove (5) formed by the inner surfaces of the longitudinal edges (14A, 14B) of the pillar (2). This allows the edges (15) of the sidewall (3) to slide into the groove (5) between the internal (8) and external (7) surfaces of the pillar (2) edge.

Each of the sidewall edges (15) also has formations complementary shaped and sized to the set off spaced apart ribs (12, 13) between the internal (8) and external (7) surfaces of the pillar edge (2). These formations include a set of notches (16A, 16B) above the position of the fastener (4) and a rib (17) located above the notches (16A, 16B). In use the notches (16A, 16B) engage the ends of the upper rib (12) in a side of the pillar (2) edge, and the rib (17) in the sidewall slides over the upper rib (12) of that pillar (2) edge. The outer edge (15A) of the sidewall (3) is also provided with a notch (18) located in a position that is aligned with the lower rib (13) of the pillar (2) edge. In use the notch (18) engages the end of the lower rib (13) in the side of the pillar (2) edge. It will be appreciated that if required for stability, the inner edge (15B) may also be provided with a notch to engage the end of the lower rib (13) in the side of the pillar (2) edge.

This arrangement allows the longitudinal edge (15) of each sidewall (3) to be slid into the groove (5) formed between the inner surfaces of the longitudinal edge (14) of the pillar (2). The abovementioned engagement of notches (16, 18) and ribs (12, 13, 17) guides each sidewall (3) into the correct position relative to the pillar (2).

The central internal wall (11) of the pillar (2) includes an aperture (19) and a passage (20) extending from the edge (19A) of the aperture closest to the external (7) surface of the pillar (2), through the external surface (7) of the pillar (2). The passage (20) is shaped and sized to allow a cap screw (21) to partly extend from the external surface (7) of the pillar (2) through the passage (20) into the aperture (19) in the internal wall (11) of the pillar (2). The head of the cap screw (21) is contained within a recessed space sized to it, with the narrower passage preventing the head from moving deeper into the pillar (2) and providing a bearing surface for the cap screw to be tightened against.

The system includes a fastener (4) as shown in FIG. 2. The fastener (4) is manufactured from a plastics material and has a rectangular base (22) with a central aperture (23) complementary shaped to the shaft of the cap screw (21). The central aperture (23) is screw threaded complementary to the thread of the cap screw (21). This is achieved by providing a screw thread in the aperture (23), alternatively by securing a nut (not shown) with a complimentary screw thread to the base (22) coaxial with the central aperture (23).

The base (22) terminates at its top and bottom in top and bottom edges, each of which is provided with a set of spaced apart protrusions (24, 25), which form the fastener guide. Each set of spaced apart protrusions define between them a gap (24A, 25A), that has a width complementary to the thickness of the internal wall (11) of the pillar (2) around the aperture (19), which provides the engagement path (19B, 19C) for the fastener (4).

The base (22) extends on each of its sides into a tab (26A, 26B). The tabs (26) each extend at degrees relative to the plane of the base (22), to arrange the tabs (26) at 90 degrees relative to each other. Each tab (26) terminates in and end that is provided with a closed aperture (27A, 27B).

Each sidewall (3) includes between its spaced apart notches (16, 18) a hook in the form of three ribs (28) each of which terminates in an end that is formed into a hook (29). The hook formations (29) each has a gap (30) that is complementary to the thickness of the tab (26) of a fastener (4) and the shape and size of its closed aperture (27).

In this first embodiment the open side of the hooks (29) are directed towards the side of the sidewall (3) which is operatively located on the inside of the portable toilet. It will be appreciated this could be reversed, with suitable functional modifications.

The base of the fastener (22) is locatable within the aperture (19) in the internal wall (11) off the pillar. The shaft of the cap screw (21) is extended through the passage (20) and through the central aperture (23) of the fastener (4) to engage the cap screw (21) with the fastener (4). The fastener (4) is arranged with its spaced apart protrusions (24, 25) on either side of the top and bottom edges (19B, 19C) of the aperture (19) in the internal wall (11).

Rotation of the cap screw (21) moves the base of the fastener (4) between the inner (19D) and outer (19A) vertical edges of the central aperture (19), guided by the protrusions (24A, 25A) along the top (19B) and bottom (19C) edges of the aperture (19). This provides an engagement path (19B 19C) between the inner (19D) and outer (19A) vertical edges of the central aperture (19) for the fastener (4). In this embodiment the engagement path (19D-19A) is aligned at 45 degrees to the sliding engagement of the sidewalls (3) into the pillar (2).

In this embodiment the fastener (4) has a disengaged position which is at the point where its base (22) is located proximate the vertical edge (19D) of the aperture (19) closest to the operative inside of the portable toilet. The fastener (4) has an engaged position at the point where the base (22) is located proximate the vertical edge (19A) of the aperture (19) closest to the operative outside of the portable toilet.

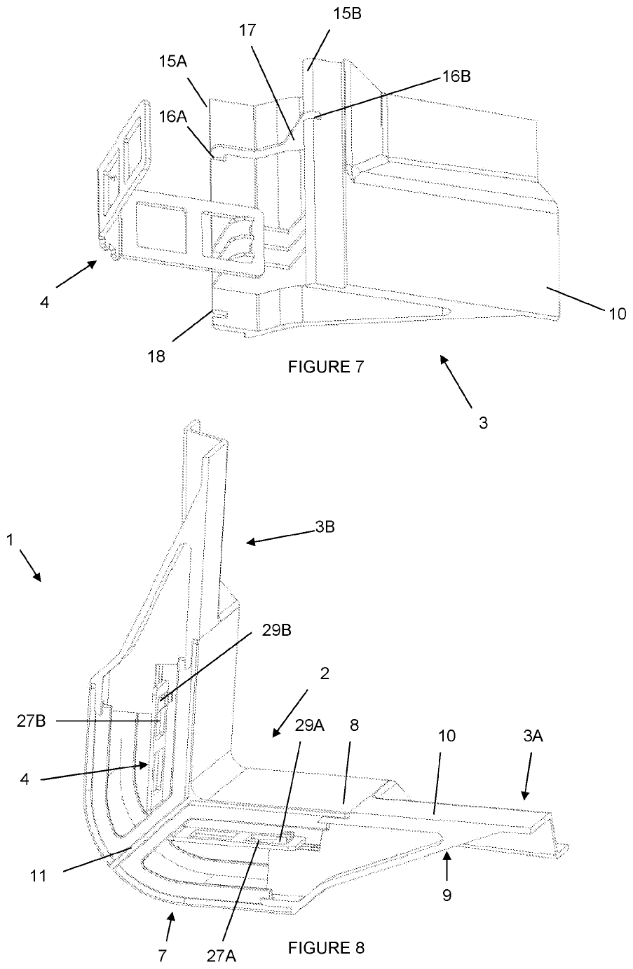

With the fastener (4) in this position, the longitudinal edges (15) of two sidewalls (3) can be slid into the complementary grooves (5) formed by the edges of the pillar (2) on either side thereof. With the sidewall edges (15) pushed fully into position the hooks (29) in the sidewall edges (15) are positioned behind and aligned with the fastener tabs (26). Rotation of the cap screw (21) moves the fastener (4) along its engagement path from the disengaged position to the engaged position. A shown in FIG. 7, with movement of the fastener (4) along the engagement path the closed aperture (27) of each tab (26) engages its respective set off hook formations (29), in the sidewall (3) on that side of the pillar (2).

As shown in FIG. 8, the 45-degree alignment of the engagement path relative to the sliding path of the sidewalls (3) into the pillar (2) ensures that the sidewalls (3) of the two panels (3A, 3B) are fully pulled into the groove (5) provided by the longitudinal edges of the pillar (2). Once the sidewalls (3) are completely in abutment with the pillar (2), the fastener (4) is in its engaged position. The plastics material of which the fastener (4) is manufactured allows a degree of deformation of the fastener (4) when it is moved into the engaged position. This ensures that the hook formations (29) are under tension which resists relative movement between the sidewalls (3) and the pillar (2).

The plurality of fasteners (4) along the length of the pillar (2) are all progressively moved from their respective disengaged to engaged positions, with a final tightening of the cap screws (21) of each ensuring that equal tension is applied along the length off the pillar (2) onto the longitudinal edges (15) of both sidewalls (3) engaged with it.

This provides a sturdy structure, which is easy to assemble and less susceptible to unwanted movement then what is possible with conventional rivets through apertures. Since the fastener is located internally with only the head of the cap screw visibly in its aperture, it is effectively concealed, and the appearance of the structure constructed from it is not diminished by the fastening system.

The assembly of a structure using this fastening system (1) is much quicker compared to rivets used in conventional systems and it requires no more than an Allen key for the caps screws (21). This fastening system (1) also allows the structure formed by it, in this embodiment a portable toilet, to be disassembled simply by moving the fasteners (4) from their engaged to their disengaged positions. The easy assembly and disassembly allow structures that use this fastening system to be flat packed and transported disassembled in bulk.

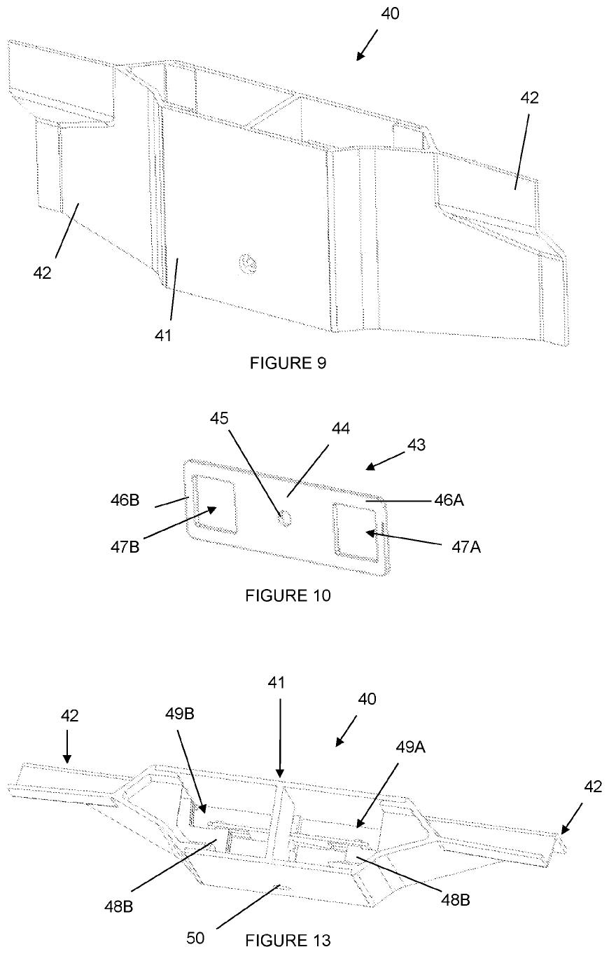

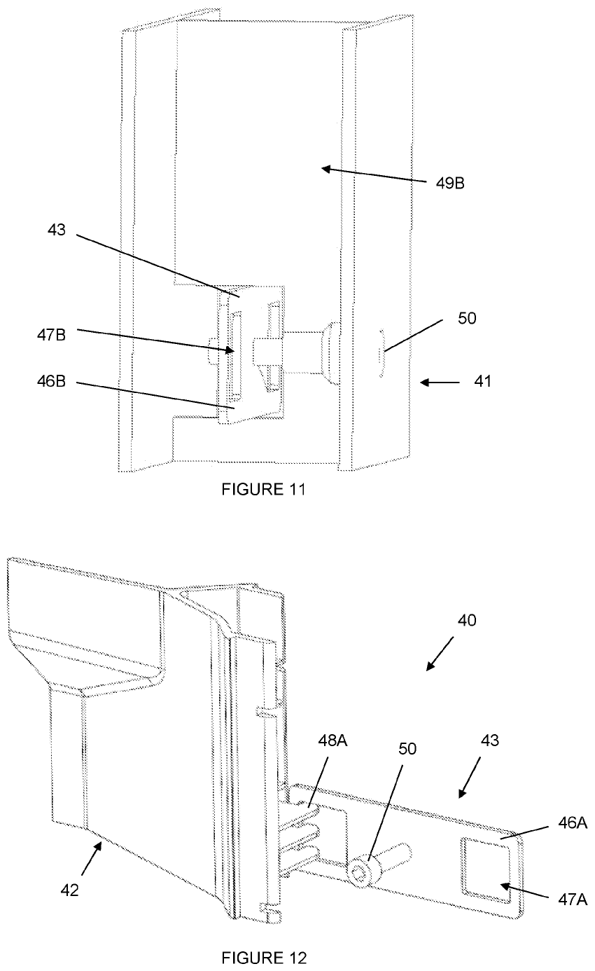

The invention is not limited to a system that requires a corner pillar (2). As shown in FIGS. 9 to 13 the fastening system of the invention includes a second embodiment (40) which can be used on a pillar (41) from which sidewalls (42) extend away from each other. This pillar (41) is therefore not a corner pillar but rather a side wall pillar. This would be useful in an instance where, for example, a structure is created that does not have a square plan but for example has a rectangular plan. That would for example include a tool shed.

In this second embodiment (40) the fastener (43) comprises a base (44) with a central aperture (45), which extends on its sides into two tabs (46A, 46B). The tabs (46) are provided with closed apertures (47A, 47B) which in use engage hook formations (48A, 48B) extending from the longitudinal edges of sidewalls (42).

In this second embodiment, the engagement path of the fastener (43) is at a right angle to the sliding path of the sidewalls (42) into the grooves (49A, 49B) provided by the longitudinal edges of the pillar (41). Even though this limits the extent by which movement of the fastener (43) from its disengaged to its engaged position will pull the sidewalls (42) into the grooves (49) of the pillar (41), the nature of the plastics material of which the fastener (43) is manufactured does allow some tension to be placed on the hook formations (48) of the sidewalls (42). Tightening of the cap screw (50) with the fastener (43) engaged over the hook formations (48) causes some deformation of the fastener (43), which tensions the hook formations (48) and draws the sidewalls (42) fully into the grooves (49) of the pillar (41).

It will be appreciated that the embodiments described above are given by way of example only and are not intended to limit the scope of the invention. It is possible to alter aspects of the embodiments without departing from the essence of the invention.

It is for example possible to provide the passage (20) through the internal surface of the pillar (2) and reverse the direction in which the hooks (29) face, to reverse the direction of the engagement path of the fastener (4). This will result in a ‘push’ engagement instead of a ‘pull’ engagement, but it is expected to still function.

It is also possible for the fastener to be provided with hooks and the sidewall with an engagement formation in the form of an aperture, extending for example from a tab. Further alternatively, a set of complimentary engaging hooks can be provided on both the fastener and the sidewall.

The fastener may also be manufactured from a non-plastic material, such as for example spring steel.

1. A concealed structural element fastening system, comprising:
a first structural element;
a second structural element; and
a fastener configured to secure the first structural element and the second structural element to, and in abutment with, each other;
with the first structural element including a fastener guide configured to movably secure the fastener to the first structural element and guide movement of the fastener along an engagement path between a disengaged position and an engaged position;
with the fastener including an engagement formation complimentary configured to an engagement formation on the second structural element,
operatively for the engagement formations of the fastener and the second structural element to become engaged with movement of the fastener from the disengaged position to the engaged position to secure the second structural element to the first structural element.

2. The concealed structural element fastening system as claimed in claim 1 wherein the second structural element has a sliding fit with the first structural element.

3. The concealed structural element fastening system as claimed in claim 2 wherein the second structural element has a sliding fit into a complementary shaped and sized space in the first structural element.

4. The concealed structural element fastening system as claimed in claim 3 wherein the complementary shaped and sized space comprises a groove.

5. The concealed structural element fastening system as claimed in claim 4 wherein the first structural element comprises a pillar and the second structural element comprises a panel, with the pillar including a longitudinal groove provided along an edge thereof, and the panel including a longitudinal edge complimentary shaped and sized to fit into the longitudinal groove at least partially, with the fastener located within the pillar and the panel's engaging formation being integrated within the edge.

6. The concealed structural element fastening system as claimed in claim 5 wherein the pillar comprises a structure comprised of an operatively outer wall and an operatively inner wall, spaced apart by an internal wall extending between them,
with the internal wall including for each fastener an aperture in the internal wall,
a passage extending from an edge of each aperture to and through the pillar wall closest to it;
with the passage shaped and sized to allow a screw threaded bolt to extend through the wall through which the passage extends into the aperture in the internal wall of the pillar,
with the fastener including a base with an aperture complementary shaped to the shaft of bolt and being screw threaded complementary to bolt,
and with the fastener guide comprising a set of spaced apart protrusions on an operatively top edge and operatively bottom edge of the fastener, with each set of protrusions defining between them a guide gap for the fastener to have a top guide gap and a bottom guide gap,
with the top and bottom guide gaps being complimentary shaped and sized to a thickness of the internal wall of the pillar at the operatively upper and lower edges of the aperture in the internal wall, to allow sliding movement of the movement along the operatively upper and lower edges of the aperture in the internal wall;
with the fastener installed in the aperture in the internal wall in screw threaded engagement with the bolt, and with the top and bottom guide gaps of the fastener being located in sliding engagement operatively upper and lower edges of the aperture in the internal wall operatively providing the engagement path for the fastener;
for rotation of the bolt to move the fastener between a disengaged position distal from the bolt passage and an engaged position proximate the bolt passage;
with the fastener further including a set of side tabs each terminating in an engagement formation that is complementary shaped and sized to an associated engagement formation of a second structural element,
operatively for movement of the fastener from its disengaged towards its engaged position to align and engage the engagement formation of each tab of the fastener with an associated complimentary engagement formation within its associated second structural element, and with movement of the fastener to its engaged position to secure the second structural element to the first structural element by drawing it into the first structural element under force of the engagement of the associated engagement formations of the fastener and the second structural element.

7. The concealed structural element fastening system as claimed in claim 6 wherein the engagement formation of each of the fastener side tabs comprises an aperture through the tab, and the engagement formation of the second structural element comprises a hook.

8. The concealed structural element fastening system as claimed in claim 6 wherein the engagement formation of each of the fastener side tabs comprises a hook extending from the tab, and the engagement formation of the second structural element comprises an aperture in a tab extending from the second structural element.

9. The concealed structural element fastening system as claimed in claim 6 wherein the passage extends through the outer wall of the pillar.

10. The concealed structural element fastening system as claimed in claim 9 wherein the first and second structural elements include a sliding fit guide comprising a set of spaced apart ribs on one of the first and second structural elements, and a set of complementary notches on the other, with the ribs and notches guiding sliding of the edge of the second structural element into the groove of the first structural element.

11. The concealed structural element fastening system as claimed in claim 10 wherein the first structural element comprises a pillar and the second structural element comprises a panel.

12. The concealed structural element fastening system as claimed in claim 11 wherein the pillar comprises a corner pillar of a structure and the panel comprises a wall of the structure.

13. The concealed structural element fastening system as claimed in claim 12 wherein each pillar provides fitment of a panel on either longitudinal side thereof.
